(19) United States
(12) Patent Application Publication
(10) Pub. No.: US 2005/0117541 A1
(43) Pub. Date: Jun. 2, 2005

(54) System and method for dynamically determining reservation parameters in a wireless network

(75) Inventor: Kevin J. Negus, Hyattville, WY (US)

Correspondence Address: Robert E. Krebs;Thelen Reid & Priest, LLP, P.O. Box 640640, San Jose, CA, 95164-0640, US

(73) Assignee: Proxim Corporation., a Delaware Corporation

(21) Appl. No.: 10/727,346

(22) Filed: Dec. 2, 2003

(51) Int. Cl. H04Q 7/00; H04B 7/00; G06F 15/16

(52) U.S. Cl. 370/329; 370/310; 709/227

(57) ABSTRACT

A wireless networking device that operates within a network protocol. The protocol supports the transmission of data by allowing a device to make a reservation for such transmission of data to one or more other wireless network devices. The wireless networking device has a dynamic reservation determination module. The module supplies a reservation parameter associated with a certain reservation amount in the wireless protocol. The dynamic reservation module can selectively change the reservation amount based on the results of prior transmissions.

### FIELD OF THE INVENTION

The present invention relates to a wireless communication system. More particularly, the present invention is related to a wireless data transfer system that reserves a particular amount of time to perform a wireless communication from among several slots for transmission.

### BACKGROUND

A popular Medium Access Control (MAC) method for wireless local area networks is a Carrier Sense Multiple Access Collision Avoidance (CSMA/CA). This method works by measuring the time since the last activity on the shared communication channel in equal length contention slots. Each transmitting unit in the network generates a random number, then counts the number of contention slots until the number is reached. At that point the transmitting node can grab the channel and other nodes must suspend their count until the channel is free again.

If, by chance, two nodes generate the same or random number and, thus, collide, they determine that the packet transfer was unsuccessful through the acknowledgement process. In this case the nodes generate a new random number to start counting slots from zero to the next time the channel is ready to transmit.

In several wireless networking protocols, such as the 802.11 wireless protocol, a transmitting node can reserve a particular slot through transmitting at that time. In this case, a node can reserve a set amount of time for the transmission cycle of the particular data.

For example, in the 802.11 protocol, the transmitting nodes reserves a particular transmission length of time by initiating a Request To Send (RTS) packet. Inside the packet, the RTS contains a field that reserves a particular amount of time for the transmission of the data. The receiving node receives the RTS and the associated reservation of time.

The receiving node then sends a Clear To Send (CTS) response. In the 802.11 protocol, the CTS also contains the reservation parameter that was sent in the RTS. In this manner, all nodes in range of the transmitting node receive the RTS and the associated reservation. Additionally, all the nodes within the transmitting range of the receiving node receive the CTS with the corresponding reservation. As such, all the nodes within the transmission range of both the transmitting node and receiving node will know the appropriate reservation for the channel. In this case all the nodes within range of both the transmitting node and receiving node will know the appropriate reservation. From this manner all the nodes within receiving range can determine not to transmit and interrupt the data link between the transmitting node and the receiving node. In this manner, the reservation effectively quiets communication around the transmitter and the receiver for the reserved period.

### SUMMARY

The invention is directed to a wireless networking device that operates under a network protocol. The protocol supports the transmission of data by allowing a device to make a reservation for such transmission of data to one or more other wireless network devices. The wireless networking device has a dynamic reservation determination mechanism. The module supplies a reservation parameter associated with a certain reservation in the wireless protocol. The dynamic reservation module can selectively change the reservation amount based on the results of prior transmissions.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a network diagram of a wireless network with a dynamically operable reservation scheme, according to the invention.

FIGS. 2a-d are energy/time diagrams detailing the effects of inappropriately sized reservations for single transmission blocks and multiple transmission blocks.

FIG. 3 is a flow chart detailing an operation of an exemplary dynamic reservation apparatus of FIG. 1.

FIG. 4 is a flow diagram of an exemplary process by which a new reservation parameter is determined, such as that depicted in FIG. 3.

FIGS. 5a and 5b are schematic views of an exemplary wireless network device operation according to the invention.

### DETAILED DESCRIPTION

Embodiments of the present invention are described herein in the context of a System And Method For Dynamically Determining Reservation Parameters In A Wireless Network. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of digital systems, including hardware, software, or any combination thereof. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

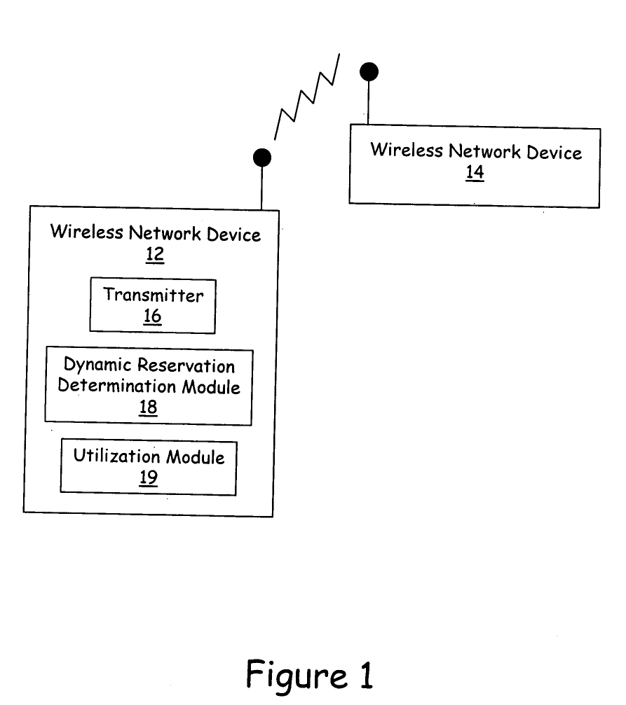

FIG. 1 is a network diagram of a wireless network with a dynamically operable reservation scheme, according to the invention. A wireless device 12 is in wireless communication with another wireless device 14. The wireless device 12 interacts with wireless device 14 under a protocol implementing a reservation type scheme, as described above.

The wireless device 12 transmits information to the wireless device 14 through the use of a transmitter 16. The wireless network device 12 receives data from an associated digital device (not shown) and formats the data into an appropriate form for transmission to the wireless device according to the particular protocol. Prior to transmission of the data, the wireless device 12 submits a reservation to the wireless device 14. In this manner, a block of transmission time is set aside for the communication link between the wireless device 12 and the wireless device 14.

In the pictured embodiment, the wireless network device 12 contains a dynamic reservation determination module 18. The dynamic reservation determination module 18 determines an appropriate reservation parameter for the wireless network device 12 to request for the transmission of data to the wireless network device 14. Thus, upon the need to transmit data, the wireless network device 12 obtains from the dynamic reservation determination module 18 an appropriate reservation parameter to be used in accordance with the transmission of data to the wireless network device 14.

After the receipt of the reservation parameter, the network wireless device 12 relays the reservation to the wireless network device 14. In the 802.11 protocol, the wireless network device transmits an RTS through the transmitter 16 to the wireless network device 14. Appropriately, under the 802.11 protocol, the wireless network device 14 then transmits a CTS to the wireless network device 12 acknowledging the reservation parameter.

Of course, other reservation schemes may be envisioned when the wireless network device 14 need not send such a responsive signal and the wireless network device 12 operates solely to transmit the reservation parameter. Or, other networking protocols may also use a reservation system that the exemplary embodiment may be adapted to. For example, in a transmission from an access point (AP) to a receiver under 802.11, the AP only sends a CTS to initialize the transmission. It should be noted that the reservation determined by the AP and transmitted to the receiver may use the dynamic reservation system described above. In this manner, the description of the invention with regards to any specific protocol is exemplary in nature, and the invention should not be read as confined to any specific wireless protocol.

The other wireless network devices within range of the wireless network device 12 and wireless network device 14 then all have at their disposal the appropriate reservation parameter that the wireless network device 12 has requested for the particular transmission. In this manner, the other wireless network devices will be inhibited from interfering with the transmission between the wireless network device 12 and the wireless network device 14.

Upon completion of the transmission of the data from the wireless network device 12 to wireless network device 14, the dynamic reservation module 18 then determines whether the reservation parameter supplied was appropriate for the actual transmission. This can be accomplished with a utilization module 19. When the reservation parameter is determined to be too large, the dynamic reservation module revises the reservation parameter downward to accommodate smaller data transmissions. When the reservation is too small for the data transmission, the dynamic reservation module 18 increases the reservation parameter to be used in future transmissions from the wireless network device 12.

Thus, subsequent transmissions of data will use the wireless medium in a more efficient manner. In the case of an underestimated reservation, the transmission is not completed in cycle, and the transmitter must attempt again to send the remaining data. This delays the transmitter while waiting for the appropriate slot. Additionally, the overhead associated with any transmission is usually large, and when the reservation is underestimated, the overhead costs are increased for both the transmitter and all those devices within range of the transmitter.

It should be noted that several packets of data may be sent in a single reservation cycle. Thus, the dynamic reservation module 18 can determine an appropriate reservation to the entire set of packets being sent to the wireless network device 14. Thus, in one reservation slot, several packets are sent in the reserved period. When the receiver the wireless network device 14 receives each packet, and acknowledgement is sent back. Thus, the dynamic reservation module 18 can make an appropriate reservation for the entire group of packets to be sent.

In this case, the wireless network device 16 may need to make a reservation for an amount of data that is larger than an internal queue size. In such a case, the reservation for sending multiple packets in the same reservation time frame may easily be for more data than is available in an internal queue for the wireless network device 16. Also, the wireless network device 16 may make a reservation for data that has yet to be introduced into its internal queue.

Assume that the wireless network device 16 contains a queue (not pictured) that is capable of handling N packets worth of data. Also assume that the requests from the attached computing device indicate to the wireless network device 16 that a reservation for multiple packets will be for M packets, where M is greater than N. In this case, the wireless network device 16 can make a reservation for the time corresponding to M packets. This is so since the a priori nature of the reservation system is independent of queue size.

In this case, the wireless network device 16 makes the reservation for transmitting M packets. The attached computing device can then download to the wireless network device 16 all or part of the first N packets. Upon transmitting the some or all of the first N packets of data, the computing device can then download some of all of the remaining M-N packets of data to the wireless network device 16. This cycle continues until all of the M packets have been related to the remote wireless network device.

In this manner, the reservation may be for more data than the internal queue can hold. Additionally, the reservation may be made while some, all, or none of the data to be sent is in the queue of the wireless network device 16.

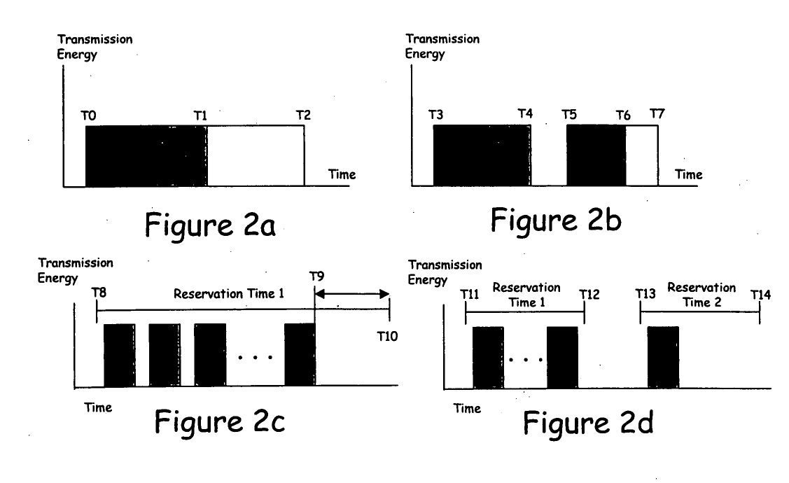

FIGS. 2a, 2b, 2c, and 2d are energy/time diagrams detailing the effects of inappropriately sized reservations. FIG. 2a is an energy/time diagram detailing the transmission characteristics of a wireless network device, such as that shown in FIG. 1, in which an over-sufficient reservation parameter has been supplied. The wireless network device has determined an appropriate reservation as that lasting from T0 to the time T2. Thus, during the actual transmission process, the transmission from the wireless network device only contains transmission energy from the time T0 to the time T1. The transmission time between T1 and T2 carries no energy, since the reservation parameter indicates too large of a time according to the data to be transmitted. In this case the inefficiency of the entire transmission cycle is measured from the time T1 to the time T2. During this inefficient period, no other wireless network devices will be transmitting to the receipt of an inappropriately sized reservation.

The energy/time diagram FIG. 2b details the opposite occurrence, when the reservation parameter is too small for the transmitted data. In this case, the wireless network device has reserved the time from T3 to T4. However, the amount of data to be transmitted is actually larger than the data to be transmitted during the reserved period. Thus, the transmission cycle between the times T3 and T4 is filled with data traffic.

However, excess data remains to be transmitted from the transmitting network device to the receiving network device. In this case, the transmitting network device will then reserve another transmission block from T5 to T7. In this case, the amount of data to be transmitted falls short of the requested amounts. As such, the time from T6 to T7 remains empty. All the while, transmissions emanating from wireless network device within the reception range of either the transmitting wireless network device or the receiving network device typically will not transmit during this time. Also, the underestimation of the reservation period to be transmitting results in multiple transmissions, each with an overhead cost and time cost to the transmitter to select another slot to transmit. Second, this results in an inefficiently formed second transmission.

FIGS. 2c and 2d detail the insufficient reservation and the oversufficient reservation in the context of the invention utilizing the reservation for a series of packets. In this manner, the transmitter sends multiple packets in the reserved block, and the receiver can acknowledge each block. Thus, the transmission of multiple packets in the reserved time is accomplished using the concepts outlined above.

FIGS. 2c and 2d detail the utilization of multi-packet reservations. In this case, the method of reserving a time for multiple blocks can be implemented in a manner as described in U.S. patent application Ser. No. 09/828,279, entitled “Asymetric Data Traffic Throughput in CSMA/CA Networks”, by Negus, which is hereby included by reference. In FIG. 2c, the system has used an oversufficient reservation for multiple blocks. The reservation was made for the period denoted between time T8 and T10. The time is set aside for a series of transmissions, not just a single transmission. In this case, the series of transmissions ends at the time T9. Thus, the time between T9 and T10 is inefficiently used.

FIG. 2d shows the other inefficiency for the reservation system showing multiple transmission blocks. In this case the system has reserved the time between T11 and T12 to send data in a multiplicity of transmissions. However, the data is not all sent. Thus, the system has to submit another reservation between times T13 and T14 to send the remainder. As explained above, this situation is also inefficient.

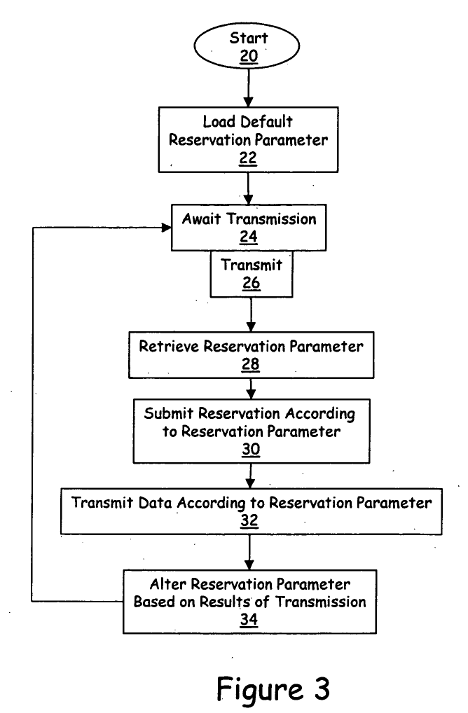

FIG. 3 is a flowchart detailing an operation of an exemplary dynamic reservation apparatus of FIG. 1. First, the system initiates operation in a block 20. Upon initiation of operation, a default reservation parameter is loaded for use in a dynamic reservation module in a block 22. This default may be a hardcoded default, or may be based on previous operation of the wireless network device. When based on previous operations, such parameters may be calculated through previous operation of the wireless network device and stored in non-volatile memory.

In any case, the system waits in outgoing transmission in a block 24. In a block 26, the wireless network device has determined to transmit an outgoing data message.

The wireless network device then prepares to reserve the appropriate time with those wireless network devices that it is in communication with. The wireless network device retrieves a reservation parameter in a block 28. For the first transmission, this parameter will be the default loaded in the block 22.

The system then submits the reservation parameter to the receiving device in a block 30. This has been previously demonstrated in the course of an 802.11 protocol through the use of the RTS/CTS mechanism.

Next, the system transmits the data from the transmitting wireless network device to the receiving wireless network device. This takes place at an appropriate slot time, and using the specified reservation parameter. This occurs in a block 32.

In a block 34, the system then selectively alters the reservation parameter. This alteration is based on whether the reservation parameter was too high for the previous transmission, or set too low.

In the case of the first operation, this alteration overwrites the default reservation parameter that was loaded in the block 22 for use in the first transmission. Of course, if the previous transmission was not the first transmission, the new reservation parameter would overwrite just previously used reservation parameter instead of overwriting the default that was loaded in the block 22.

After an appropriate new reservation parameter is stored, the system returns to await another outgoing transmission in the block 24. Thus, the reservation parameter is dynamically altered based on the previous usage characteristics. When the reservation parameter is too high for current conditions, the new reservation parameter is determined by lowering the previous one. When it is determined that the reservation parameter was too low, it is raised by some amount.

It should be noted that this methodology is proper for both the cases diagrammed in FIGS. 2a-b, and 2c-d. In this manner, the reservation is determined for the outgoing data, whether the data is split up among several contiguous blocks or single blocks.

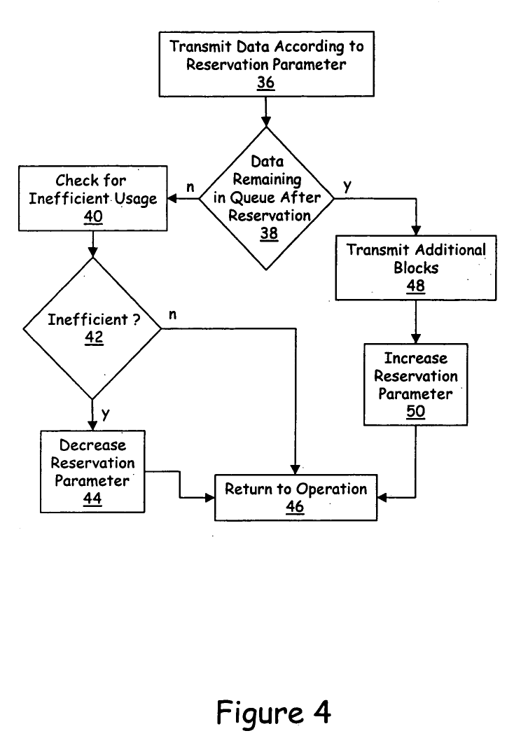

FIG. 4 is a flow diagram of an exemplary process by which a new reservation parameter is determined, such as that depicted in FIG. 3. In a block 38, the system determines if all the data set was transmitted in the current reserved portion.

If only one transmission was needed to send all of the current data, it is possible that the time reserved was overestimated. In a block 40, the system determines if the reserved transmission time was underutilized.

In this case, the under-utilization, if any, may be determined by comparing the actual transmission time to the reserved transmission time. In one case, if the ratio of the actual transmission time to the reserved transmission time falls below a predetermined amount, the system may determine that the reservation parameter is too large. Of course, the ratios used in the determination of under-utilization may be alterable, or other schemes may be used to determine when the under-utilization has occurred.

If the system determines that the transmission reservation was underutilized in a block 42, control flows to a block 44 when the reservation parameter is reduced by some amount. In an exemplary embodiment, the reservation parameter is decremented by some predefined amount. In the exemplary embodiment, the predefined amounts may be a predefined time, or a time indicative of a predefined amount of data. After updating the reservation parameter in block 44, the system returns to operation in a block 46, such as that depicted in FIG. 3.

When, within the block 42, it is determined that the transmission was not underutilized, the control flows back to normal operation in the block 46, such as that depicted in FIG. 3. In this case, the reservation parameter is neither reduced nor enhanced by any amount.

If, in the block 38, the process determines if more than the first transmission was needed to send all the data in the current data set transmission, control flows to a block 48. In the block 48 the additional data is transmitted. Next, in a block 50, the reservation parameter is incremented or raised by a predetermined amount. Finally, the system returns to operation in the block 46.

In an exemplary embodiment, the reservation parameter is incremented by a predetermined amount of time or time to deliver a predetermined amount of data. After the reservation parameter has been incremented in the block 50, control returns to the system, such as the exemplary embodiment depicted in FIG. 3.

Of course, the amounts of enhancement or reduction of the reservation parameter may be accomplished in many different ways. As stated before, this may be a predefined amount of time, a time corresponding to a predefined amount of data transmission, or may be based on the ratio of the utilization of the actual transmission time to the reserved time. Other schemes may be envisioned where a moving average may be used, a predictive filter may be employed, or any other statistical, computational, or filtering methods may be used for determining amounts to raise or lower the reservation parameter.

In one exemplary embodiment, multiple reservation parameters are used. Thus, when a first wireless network device transmits to a second wireless network device, a first parameter may be used in the transmission. When the first wireless network device communicates with a third wireless network device, the type of data transmitted may be completely different from the type transmitted between the first wireless network device and the second wireless network device. In this case, the reservations used for each pair of wireless network device may be completely different. Thus, in an exemplary embodiment, multiple reservation parameters are stored for the wireless network device pairs. In this manner, only the appropriate reservation parameter is modified.

When the system determines that the reservation parameter is insufficient and is required to perform multiple transmissions to send the current data, the system may also determine another new or appropriate reservation parameter other points. Accordingly, the new reservation parameter may be updated either between multiple transmissions of the same data sets, between transmissions of a multiple data sets, or any combination therein.

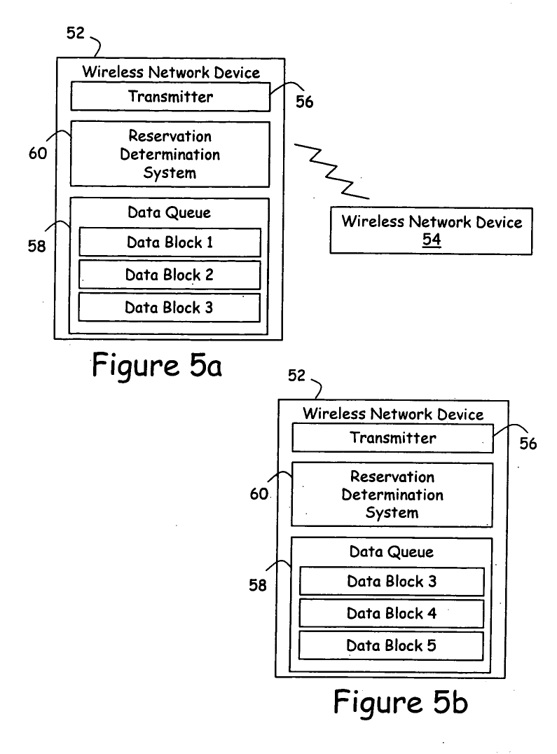

FIGS. 5a and 5b are schematic block diagrams detailing the implementation of a wireless network device, according to one aspect of the invention. A wireless network device 52 transmits data to the wireless network device 54. The wireless network device 52 contains a transmitter 56, a data queue 58, and a reservation determination system 60. In one aspect of the invention, the wireless network device 52 is coupled to a data provider (not pictured) that streams data to be transmitted to the wireless network device 54.

The data to be transmitted enters to the wireless network device 52 and is stored in the data queue 58. The dynamic reservation determination system 60 determines a proper reservation to be used in the transmission of the data to the wireless network device 54. In this case, the wireless network device 52 has 3 original blocks of data stored, and the dynamic reservation system determines that a reservation of six blocks is necessary for the particular transmission. Note, in this case, the reservation determination system can make this determination without all the data present in the wireless network device 52.

In this case, the dynamic reservation determination system 60 determines that a plurality of blocks will be transmitted under one reservation timeframe. In one case, the multiple blocks sent under the reservation will look in the transmission domain much like the transmission of data occurring in FIGS. 2c and 2d. That is, the various blocks will be sent to the wireless network device 54 in multiple packets. Thus, the reservation is not just for one single packet transmission, but is for the series of packets making up the entire data transfer, whether that data is present in the wireless network device 54 or not. The appropriate reservation is made and the transmission of data is started.

In some cases, the reservation will be for more data than is currently present in the queue 58. Thus, the wireless network device 52 will send the data to the wireless network device 54, and take the sent data out of the queue 58. As the queue 58 is emptied, more data in the entire dataset to be sent to the wireless network device 54 is sent to the wireless network device 52 from the data provider. Accordingly, the new data is placed in the queue 58 and sent out.

In an exemplary embodiment, FIG. 5a indicates that at the start of the transmission cycle, three blocks of data are ready for transfer to the wireless network device 54. In this case assume that a data block 4 and a data block 5 are part of the entire data being transmitted to the wireless network device 54. Thus, the reservation made by the wireless network device 52 can be for a block of time to send the entire data set, not just the data present. Thus, the reservation is made in an a priori basis for a dataset that includes data block 4 and data block 5, even though the data blocks are not present.

FIG. 5b is the schematic diagram of the sending wireless network device of FIG. 5a at a point in time after the first data of the reservation has been sent to the wireless network device 54. FIG. 5b indicates that in the reserved time, data block 1 and data block 2 have been sent, and data block 4 and data block 5 are in the queue to be transmitted.

The determination of the reservation in an a priori basis also enables the wireless network device 52 to send data to the wireless network device 54 prior to all the data being in the queue 58, for whatever reason. Thus, the streaming data may enter the queue 58 and be sent to the wireless network device 54. All the while, new data to be sent to the wireless network device 54 in the same reservation period is being placed into the queue 58 after being received by the wireless network device 52 from the data provider. Thus, the reservation can correspond to more data than is actually in the queue 58. Or, the reservation can correspond to data that is not currently present in the queue 58.

After transmission of a certain amount, new data is placed into the queue 58. Thus, the reservation is not simply for data in the queue, but can correspond to data that is not in the queue 58 at the time that the reservation is made.

Thus, a method and apparatus for dynamically altering a reservation parameter in wireless network protocol is described and illustrated. Those skilled in the art will recognize that many modifications and variations of the present invention are possible without departing from the invention. Of course, the various features depicted in each of the Figures and the accompanying text may be combined together. Accordingly, it should be clearly understood that the present invention is not intended to be limited by the particular features specifically described and illustrated in the drawings, but the concept of the present invention is to be measured by the scope of the appended claims. It should be understood that various changes, substitutions, and alterations could be made hereto without departing from the spirit and scope of the invention as described by the appended claims that follow.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. A wireless networking device operating within a network protocol in which a reservation is made for transmission of data to one or more other wireless network devices, the wireless networking device comprising:
a dynamic reservation determination module, the module supplying a reservation parameter associated with a reservation of a certain length, the transmission of data corresponding to multiple separate transmissions within the certain length, the dynamic reservation module selectively changing the reservation parameter based on the results of prior transmissions.

2. The device of claim 1, wherein the dynamic reservation determination module determines if a last transmission reservation was oversufficient, and if the last transmission was oversufficient, decreases the reservation.

3. The device of claim 2 wherein the dynamic reservation determination module decreases the reservation by a predefined amount.

4. The device of claim 3 wherein the dynamic reservation determination module decreases the reservation by a predefined amount of time

5. The device of claim 3 wherein the dynamic reservation determination module decreases the reservation by an amount associated with a predefined amount of data.

6. The device of claim 2 wherein the dynamic reservation determination module decreases the reservation by a computed amount.

7. The device of claim 6 wherein the computed amount is obtained through filtering.

8. The device of claim 1 wherein the first reservation is based on a predefined default value.

9. The device of claim 1 wherein the first reservation is based on a value determined by prior operation.

10. The device of claim 1, wherein the dynamic reservation determination module determines if a last transmission reservation was insufficient, and if the last transmission reservation was insufficient, increases the reservation.

11. The device of claim 10 wherein the dynamic reservation determination module increases the reservation by a predefined amount.

12. The device of claim 11 wherein the dynamic reservation determination module increases the reservation time by a predefined amount.

13. The device of claim 11 wherein the dynamic reservation determination module increases the reservation time by a time associated with a predefined amount of data.

14. The device of claim 10 wherein the dynamic reservation determination module increases the reservation by a computed amount.

15. The device of claim 14 wherein the computed amount is obtained through filtering.

16. A wireless networking device operating within a network protocol in which a reservation is made for transmission of data with a dynamically updateable reservation parameter, the wireless networking device comprising:
a utilization module, the utilization module determining the efficiency characteristics of the reservation, and initiating a signal to alter the reservation parameter.

17. A wireless networking device operating within a network protocol in which a reservation is made for transmission of data, the wireless networking device comprising:
a utilization module, the utilization module determining the efficiency characteristics of a the reservation, and initiating a signal associated with the determined efficiency; and
a dynamic reservation determination module, communicatively coupled to the utilization module, that supplies a reservation parameter for making a reservation of a certain length, the dynamic reservation module operable to alter the reservation parameter in response to the signal generated by the utilization module.

18. The wireless networking device of claim 17 wherein the full transmission of data is made with multiple transmissions of packets.

19. A method of altering the operating characteristics of a wireless network connection associated with a wireless network device, the wireless network device operable to transmit data to another wireless network device under a network protocol that has a reservation, the reservation associated with a reservation parameter, the method comprising:
monitoring the transmission;
determining the utilization of the transmission;
selectively, based on the step of determining, altering the reservation parameter; and
wherein the full transmission of data occurs with multiple transmissions of packets

19. A method for operating a wireless networking device that communicates data under a network protocol, the network protocol including a reservation for a transmission of data to one or more other wireless network devices, the method comprising:
supplying a reservation parameter associated with a particular reservation amount; and
selectively changing the reservation parameter based on the results of prior transmissions.

20. The method of claim 19, further comprising:
determining if a last transmission reservation was oversufficient; and
the step of selectively changing comprising:
selectively, if the last transmission was oversufficient, decreasing the reservation.

21. The method of claim 20, the step of selectively decreasing comprising:
decreasing the reservation by a predefined amount.

22. The method of claim 21 wherein the predefined amount is a predefined amount of time

23. The method of claim 21 wherein the predefined amount is associated with a predefined amount of data based on operating characteristics of the networking device.

24. The method of claim 20, the step of selectively decreasing comprising:
decreasing the reservation by a computed amount.

25. The method of claim 24 wherein the computed amount is obtained through filtering.

26. The method of claim 19 further comprising
prior to the first transmission, supplying a first reservation based on a predefined default value.

27. The method of claim 19 further comprising
prior to the first transmission, supplying a first reservation a value based on prior operation.

28. The method of claim 19, further comprising:
determining if a last transmission reservation was insufficient; and
the step of selectively changing comprising:
selectively, if the last transmission was insufficient, increasing the reservation.

29. The method of claim 28, the step of selectively increasing comprising:
increasing the reservation by a predefined amount.

30. The method of claim 29 wherein the predefined amount is a predefined amount of time

31. The method of claim 29 wherein the predefined amount is associated with a predefined amount of data based on operating characteristics of the networking device.

32. The method of claim 28, the step of selectively increasing comprising:
increasing the reservation by a computed amount.

33. The method of claim 24 wherein the computed amount is obtained through filtering.

34. A wireless networking device operating within a network protocol in which a reservation is made for transmission of data, the wireless networking device comprising:
utilization monitoring means, the utilization monitoring means determining the efficiency characteristics of a transmission, and initiating a signal associated with the determined efficiency; and
means for selectively determining a reservation, communicatively coupled to the utilization monitoring means, that supplies a reservation parameter for making a reservation of a certain length, the means for selectively determining a reservation operable to alter the reservation parameter in response to the signal generated by the utilization monitoring means.

35. The device of claim 34, wherein:
the utilization monitoring means comprising:
a means for determining if a last transmission reservation was oversufficient; and
the means for selectively determining a reservation comprising:
means for decreasing the reservation based upon if the last transmission was oversufficient

36. The device of claim 35, wherein the means for decreasing is operable to decrease the reservation by a predefined amount.

37. The device of claim 36 wherein the predefined amount is a predefined amount of time

38. The device of claim 36 wherein the predefined amount is associated with a predefined amount of data based on operating characteristics of the networking device.

39. The device of claim 35, the means for decreasing comprising:
means for decreasing the reservation by a computed amount.

40. The device of claim 39 wherein the computed amount is obtained through filtering.

41. The device of claim 34 further comprising
means for supplying a first reservation, prior to the first transmission, the first reservation based on a predefined default value.

42. The device of claim 34 further comprising
means for supplying a first reservation, prior to the first transmission, the first reservation based on a value determined by previous operation of the device.

43. The device of claim 34, wherein:
the utilization monitoring means comprising:
a means for determining if a last transmission reservation was insufficient; and
the means for selectively determining a reservation comprising:
means for increasing the reservation based upon if the last transmission was insufficient

44. The device of claim 43, wherein the means for increasing is operable to increase the reservation by a predefined amount.

45. The device of claim 44 wherein the predefined amount is a predefined amount of time

46. The device of claim 44 wherein the predefined amount is associated with a predefined amount of data based on operating characteristics of the networking device.

47. The device of claim 43, the means for increasing comprising:
means for increasing the reservation by a computed amount.

48. The device of claim 47 wherein the computed amount is obtained through filtering.

49. A wireless networking device operating within a network protocol in which a reservation is made for transmission of data, the wireless networking device communicating to two or more other wireless networking devices, the wireless networking device comprising:
a utilization module, the utilization module determining the efficiency characteristics of a transmission, and initiating a signal associated with the determined efficiency;
a dynamic reservation determination module, communicatively coupled to the utilization module, that supplies a reservation parameter for making a reservation of a certain length, the dynamic reservation module operable to alter the reservation parameter in response to the signal generated by the utilization module;
the wireless networking device using and selectively altering a first dynamic reservation parameter when communicating with a first other wireless networking device; and
the wireless networking device using and selectively altering a second dynamic reservation parameter when communicating with a second other wireless networking device.

50. A wireless networking device operating with a network protocol in which a reservation is made for transmission of data to one or more other wireless network devices, the wireless networking device comprising:
a reservation determination module, the module supplying a reservation parameter associated with a reservation of a certain length; and
the reservation parameter associated with the transmission of data in multiple packets within the associated reservation.

51. A wireless networking device operating with a network protocol in which a reservation is made for transmission of a dataset to one or more other wireless network devices, the wireless networking device comprising:
a transmitter that transmits the dataset to the one or more other wireless network devices, the transmitted dataset being transmitted in multiple groupings of data;
a data queue, communicatively coupled to the transmitter, that holds the data to be transmitted;
a reservation determination module, the module supplying a reservation parameter associated with a reservation of a length, the length associated with an estimated length to transmit the entire multiple groupings of data;
wherein the reservation parameter is operable to supply the reservation parameter prior to all data in the dataset being present in the data queue.

52. A wireless networking device operating with a network protocol in which a reservation is made for transmission of a dataset to one or more other wireless network devices, the wireless networking device comprising:
a transmitter that transmits the dataset to the one or more other wireless network devices, the transmitted dataset being transmitted in multiple groupings of data;
a data queue, communicatively coupled to the transmitter, that holds the data to be transmitted;
a reservation determination module, the module supplying a reservation parameter associated with a reservation of a length, the length associated with an estimated length to transmit the entire multiple groupings of data;
wherein the reservation parameter corresponds to a dataset size larger than can be store at one time in the data queue.
